(19) United States
(12) Patent Application Publication
(10) Pub. No.: US 2026/0244533 A1
(43) Pub. Date: Aug. 20, 2026

(54) DATA BUFFER ERROR CORRECTION FUNCTIONALITY

(71) Applicant: Micron Technology, Inc., Boise, ID (US)

(72) Inventors: Anthony D. Veches, Boise, ID (US); Sujeet V. Ayyapureddi, Boise, ID (US); Frank F. Ross, Boise, ID (US); Scott E. Schaefer, Boise, ID (US); Randall J. Rooney, Boise, ID (US); Navid Lashkarian, Pleasanton, CA (US); Matthew A. Prather, Boise, ID (US); Lance W. Dover, Fair Oaks, CA (US)

(21) Appl. No.: 19/537,270

(22) Filed: Feb. 11, 2026

Related U.S. Application Data
(60) Provisional application No. 63/759,984, filed on Feb. 18, 2025.

(51) Int. Cl. G06F 11/10

(52) U.S. Cl. CPC G06F 11/1076; G06F 11/1068

(57) ABSTRACT

Methods, systems, and devices for data buffer error correction functionality are described. A data buffer of a memory system may support system-level error correction capabilities. For example, the data buffer may be configured to perform error correction for data stored within multiple memory dies in the memory system using parity bits aggregated from one or more of the memory dies. In some examples, on-die error correction at one or more of the memory dies may be disabled. Extra parity bits previously used for on-die error correction may be transferred from the memory dies to the data buffer for use in the system-level error correction. The aggregation of the extra bits for error correction within the data buffer may improve a performance and reliability of the system-level error correction.

### CROSS REFERENCE

The present Application for Patent claims priority to U.S. Patent Application No. 63/759,984 by Veches et al., entitled “DATA BUFFER ERROR CORRECTION FUNCTIONALITY,” filed February 18, 2025, which is assigned to the assignee hereof, and which is expressly incorporated by reference in its entirety herein.

### TECHNICAL FIELD

The following relates to one or more systems for memory, including data buffer error correction functionality.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports data buffer error correction functionality in accordance with examples as disclosed herein.

FIG. 2 shows an example of a system that supports data buffer error correction functionality in accordance with examples as disclosed herein.

FIG. 3 shows an example of a process flow that supports data buffer error correction functionality in accordance with examples as disclosed herein.

FIG. 4 shows a block diagram of a memory system that supports data buffer error correction functionality in accordance with examples as disclosed herein.

FIG. 5 shows a flowchart illustrating a method or methods that support data buffer error correction functionality in accordance with examples as disclosed herein.

### DETAILED DESCRIPTION

Some memory systems may include multiple memory dies (e.g., memory devices). Each memory die may include one or more memory arrays for storage of data. In some examples, one or more of the memory dies may be configured with on-die error correction capabilities (e.g., on-die error correction code (ECC)) to correct errors when reading and writing data to the die. That is, the one or more memory dies may include an on-die error correction component that may perform error detection and correction for data stored at the memory die. Although the on-die error correction may detect and correct errors in data stored to the memory die, there may still be errors that occur as data is transferred via a memory channel within the memory system (e.g., a module). As such, the data transferred from the memory system to a host system may include errors, in some examples. Additionally, or alternatively, one or more memory dies in the memory system may be reserved for storage of system-level parity information, which may be used to detect and correct errors at a system-level (e.g., errors that occur as data is transferred over the memory channel). The reservation of such dies for parity information may reduce storage efficiency. Thus, the combination of on-die error correction and storage of parity for system-level error correction may reduce storage efficiency and increase overhead, in some examples. Additionally, or alternatively, for a host system to perform error correction, additional bits may be exchanged over an interface between the memory system and the host system, which may increase input/output (I/O) overhead and reduce efficiency.

Techniques, systems, devices, and apparatuses described herein provide for a system-level error correction capability within a data buffer of a memory system. The data buffer may be configured to perform error correction for data stored within multiple memory dies in the memory system using parity bits aggregated from one or more of the memory dies. To facilitate such system-level correction within the buffer, the on-die error correction at one or more of the memory dies may be disabled. One or more extra bits previously used for on-die error correction by the one or more memory dies may be transferred from the memory dies to the data buffer for use in the system-level error correction. That is, instead of correcting data on each memory die, the data and one or more extra bits may be transferred to the data buffer and combined for error correction within the data buffer before being transferred to a host system. By disabling the on-die error correction at one or more of the memory dies and using the extra bits within the data buffer for system-level correction, one or more extra memory dies previously reserved for storage of parity information may be removed to reduce a footprint of the memory system, reduce power consumption, and reduce costs overall, among other examples.

In some examples, the data buffer and the memory dies may support dynamic adjustment of the system-level error correction over time. For example, the data buffer and the on-die error correction engines may each include or otherwise be coupled with one or more mode registers, pins, or the like that are configured to receive an indication of a change in an error correction algorithm. The error correction engine within the data buffer and the one or more on-die error correction engines may thereby modify the error correction techniques they are implementing based on the indication. In some examples, to switch an error correction algorithm (e.g., a level of error correction) for a given portion of data, the memory system may access the portion of the data, decode the portion of the data using the first error correction algorithm, re-encode the portion of the data using the second error correction algorithm, and store the portion of the data encoded using the second error correction algorithm back to the memory. The dynamic adjustments may shift where extra bits within the memory system are being used for error correction based on one or more parameters or scenarios associated with the host system or a user of the memory system.

In addition to applicability in memory systems as described herein, techniques for data buffer error correction functionality may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds and error correction reliability at a system-level, which may decrease processing or latency times, improve response times, or otherwise improve user experience, among other benefits.

In addition to applicability in memory systems described herein, techniques for data buffer error correction functionality may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by improving reliability of error correction for data being transferred to a host system, and may prevent or mitigate errors within data, improve reliability of the memory system, and incur lower latency costs (e.g., by implementing it at hardware level), among other benefits.

In addition to applicability in memory systems as described herein, techniques for data buffer error correction functionality may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by reducing an overall footprint of a memory system and reducing materials used in production of electronic devices, which may result in lowered production emissions, reduce electronic waste, and extend the life of electronic devices, thereby reducing electronic waste, among other benefits.

Features of the disclosure are illustrated and described in the context of systems and architectures. Features of the disclosure are further illustrated and described in the context of a process flow and flowcharts.

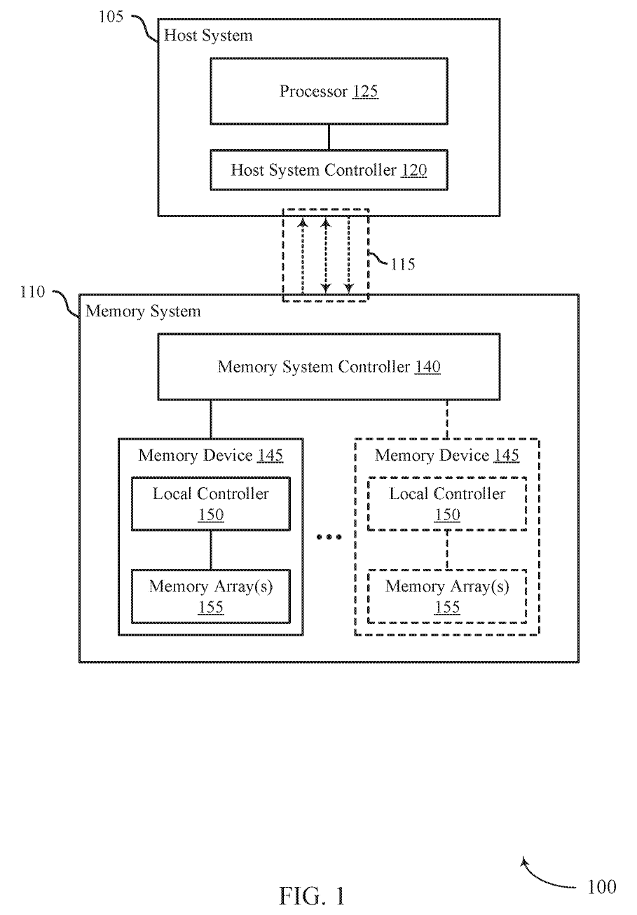

FIG. 1 illustrates an example of a system 100 that supports data buffer error correction functionality in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

The host system 105 may include one or more components (e.g., circuitry, processing circuitry, one or more processing components) that use memory to execute processes, any one or more of which may be referred to as or be included in a processor 125. The processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. The processor 125 may be an example of a central processing unit (CPU), a graphics processing unit (GPU), a general-purpose GPU (GPGPU), or an SoC or a component thereof, among other examples.

The host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating the memory system 110, such as write commands, read commands, configuration signaling or other operational signaling. In some examples, the host system controller 120, or associated functions described herein, may be implemented by or be part of the processor 125. For example, a host system controller 120 may be hardware, instructions (e.g., software, firmware), or some combination thereof implemented by the processor 125 or other component of the host system 105. In various examples, a host system 105 or a host system controller 120 may be referred to as a host.

The memory system 110 provides physical memory locations (e.g., addresses) that may be used or referenced by the system 100. The memory system 110 may include a memory system controller 140 and one or more memory devices 145 (e.g., memory packages, memory dies, memory chips) operable to store data. The memory system 110 may be configurable for operations with different types of host systems 105, and may respond to commands from the host system 105 (e.g., from a host system controller 120). For example, the memory system 110 (e.g., a memory system controller 140) may receive a write command indicating that the memory system 110 is to store data received from the host system 105, or receive a read command indicating that the memory system 110 is to provide data stored in a memory device 145 to the host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of the memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with the host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 and one or more memory arrays 155. A memory array 155 may be a collection of memory cells (e.g., a two-dimensional array, a three-dimensional array), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

A command/address channel (e.g., a CA channel) may be operable to communicate commands between the host system 105 and the memory system 110, including control information associated with the commands (e.g., address information, configuration information). Commands carried by a command/address channel may include a write command with an address for data to be written to the memory system 110 or a read command with an address of data to be read from the memory system 110.

A clock signal channel may be operable to communicate one or more clock signals between the host system 105 and the memory system 110. Clock signals may oscillate between a high state and a low state, and may support coordination (e.g., in time) between operations of the host system 105 and the memory system 110. In some examples, a clock signal may provide a timing reference for operations of the memory system 110. A clock signal may be referred to as a control clock signal, a command clock signal, or a system clock signal. A system clock signal may be generated by a system clock, which may include one or more hardware components (e.g., oscillators, crystals, logic gates, transistors).

A data channel (e.g., a DQ channel) may be operable to communicate (e.g., bidirectionally) information (e.g., data, control information) between the host system 105 and the memory system 110. For example, a data channel may communicate information from the host system 105 to be written to the memory system 110, or information read from the memory system 110 to the host system 105. In some examples, channels 115 may include one or more error detection code (EDC) channels. An EDC channel may be operable to communicate error detection signals, such as checksums or parity bits, which may accompany information conveyed over a data channel.

Signaling may be communicated over the channels 115 using single data rate (SDR) signaling or double data rate (DDR) signaling, among other rates (e.g., relative to a clock signal). In SDR signaling, one modulation symbol (e.g., signal level) of a signal may be registered for each clock cycle (e.g., on a rising edge or a falling edge of a clock signal). In DDR signaling, two modulation symbols of a signal may be registered for each clock cycle (e.g., on both a rising edge and a falling edge of a clock signal).

Signals communicated over the channels 115 may be modulated using various modulation schemes or combinations thereof. A symbol of a binary-symbol (e.g., binary-level) modulation scheme may be operable to represent one bit of data (e.g., a symbol may represent a logic 1 or a logic 0), and may be an example of an M-ary modulation scheme where M is equal to two. Examples of binary-symbol modulation schemes include non-return-to-zero (NRZ), unipolar encoding, bipolar encoding, Manchester encoding, pulse amplitude modulation (PAM) having two symbols (e.g., PAM2), and others. A symbol of a multi-symbol modulation scheme may be operable to represent more than one bit of data (e.g., a symbol may represent a logic 00, a logic 01, a logic 10, or a logic 11), and may be an example of an M-ary modulation scheme where M is greater than or equal to three. For example, a multi-symbol signal may be modulated using a modulation scheme that includes at least three levels to encode more than one bit of information. Multi-symbol modulation schemes and symbols may be referred to as non-binary, multi-bit, or higher-order modulation schemes and symbols. Examples of multi-symbol modulation schemes include PAM3, PAM4, PAM8, and so on, quadrature amplitude modulation (QAM), quadrature phase shift keying (QPSK), and others.

In some cases, each memory device 145 may include on-die error correction circuitry (e.g., an on-die ECC engine) configured to detect and correct errors in data stored to the memory device 145 before transferring the data off of the memory device 145 to the memory system controller 140, the host system 105, or both. The memory devices 145 may each store some amount of data as well as one or more parity bits allocated for the on-die error correction. For example, if a prefetch size inside a memory array 155 is 128 bits, eight bits may be allocated for error correction. In this example, a single bit may be corrected, by the on-die error correction circuitry, within every 128 bits of data that are prefetched. It is to be understood that the bit quantities may vary across dies, but there may be at least one or more parity bits within each memory device 145 that is allocated for on-die error correction.

Within the memory system 110 (e.g., at the module-level), there may be multiple memory devices 145. For example, there may be 10 memory devices 145 within a memory system 110 (e.g., 10 x4 memory devices 145), or some other quantity of memory devices 145. One or more of the memory devices 145 may store parity information and may output, to the host system 105, parity bits for system-level error correction and detection. In some examples, if the memory system 110 includes 10 memory devices 145, eight of the memory devices 145 may store data and parity bits for on-die error correction within the memory arrays 155 and may output the data. The parity bits for on-die error correction may remain within the memory devices 145 and may not be transferred outside of the memory devices 145, in some examples. Two of the memory devices 145 may store, within the memory arrays 155, and output parity bits for the system-level correction. The memory system 110 may thereby receive a read command, obtain the requested data from the memory device(s) 145, obtain parity bits from the one or more parity memory devices 145, and transfer, to the host system 105 via the one or more channels 115, the data and the parity bits. The host system 105 may perform the system-level error correction.

However, such techniques may result in the memory system 110 sending data with one or more errors to the host system 105. For example, the on-die error correction circuitry may correct errors that arise as data is stored on the dies over time, but one or more other errors may occur as the data is transferred from the memory devices 145 to an input/output (I/O) component, for example. Additionally, or alternatively, sending the extra parity bits to the host system 105 may be associated with increased power consumption and overhead, which may reduce throughput and reliability of the system, among other examples.

Techniques, systems, and devices described herein provide for aggregation of bits for error correction at the module-level. That is, a data buffer within the memory system 110 may be configured to perform system-level error correction scheme, which may provide for fewer bits to be transmitted to the host system 105, fewer memory devices 145 to store additional parity information, or both. Additionally, or alternatively, the data buffer performing the system-level error correction may improve reliability of data that is sent over the one or more channels 115 to the host system 105. That is, when data is transferred to the host system 105, the host system 105 may identify any errors within the data and associate such errors to the one or more channels 115 (e.g., instead of to any internal errors within the memory system 110).

To facilitate such system-level correction within the buffer, the on-die error correction at one or more of the memory devices 145 may be disabled. One or more extra bits previously used for on-die error correction by the one or more memory devices 145 may be transferred from the memory devices 145 to the data buffer for use in the system-level error correction. That is, instead of correcting data on each memory device 145, the data and one or more extra bits may be transferred to the data buffer and combined for error correction within the data buffer before being transferred to the host system 105. By disabling the on-die error correction at one or more of the memory devices 145 and using the extra bits within the data buffer for system-level correction, one or more extra memory devices 145 previously reserved for storage of parity information may be removed to reduce a footprint of the memory system 110, reduce power consumption, and reduce costs overall, among other examples.

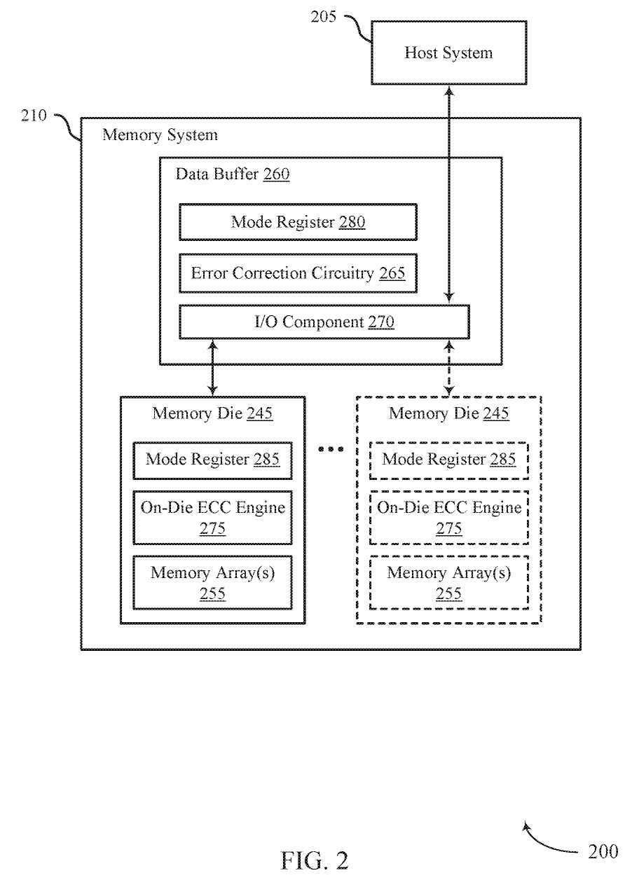

FIG. 2 illustrates an example of a system 200 that supports data buffer error correction functionality in accordance with examples as disclosed herein. The system 200 represent an example of a system 100 or one or more components thereof. As described herein, the system 200 may include a memory system 210 that supports system-level (e.g., module-level) error correction within a data buffer 260 before data is conveyed to a host system 205. The memory system 210 and the host system 205 may represent examples of corresponding systems as described herein, including with reference to FIG. 1.

The memory system 210 may represent an example of a module including one or more memory dies 245, which may represent examples of the memory devices 145 described with reference to FIG. 1. Each of the memory dies 245 may include one or more memory arrays 255 configured to store data, parity bits, metadata, or the like. In some examples, each of the memory dies 245 may also include a respective on-die ECC engine 275, which may represent an example of error correction circuitry configured to detect errors, correct errors, or both within the data stored to the memory arrays 255 of the memory die 245.

The memory system 210 may include a memory system controller 160, as described and illustrated with reference to FIG. 1. In this example, the memory system 210 may additionally include the data buffer 260. The data buffer 260 may be coupled with the memory system controller 160, in some examples, and may be configured to transfer and buffer data between the host system 205 and the memory dies 245. All data that enters the memory system 210 from the host system 205 or that is transferred to the host system 205 from the memory system 210 may be transferred through the data buffer 260. For example, the data buffer 260 may include or otherwise be coupled with an I/O component 270 configured to facilitate the transfer of data to and from the memory system 210 via one or more channels, such as the one or more channels 115 described with reference to FIG. 1 (e.g., a link). The data buffer 260 may thereby be the point where all data leaving the memory system 210 to the host system 205 (e.g., system on chip (SoC)) passes through.

Techniques described herein provide for a system-level error correction functionality within the data buffer 260. That is, the data may be corrected at a system level within the data buffer 260 before the data is transferred to the host system 205, which may improve performance, in some examples. For example, transferring the parity bits from one or more of the memory dies 245 configured to store parity information to the data buffer 260 may consume less power and overhead than transferring the parity bits off of the memory system 210 to the host system 205. Shipping the extra bits (e.g., 80 extra parity bits, or some other quantity) to the host system 205 may increase energy and overhead. Additionally, or alternatively, exposing the parity bits outside of the memory system 210 may pose security risks. Since the data buffer 260 is local to the memory system 210, the energy expended to move the extra bits may be less than energy to ship the bits to the host system 205, and security within the memory system 210 may be maintained.

Thus, as described herein, the data buffer 260 may receive, in response to a read command, data from one or more of the memory dies 245, as well as one or more parity bits from the parity memory dies 245 (e.g., the memory dies 245 that only store parity information). The data buffer 260 may include the error correction circuitry 265, which may be configured to perform an error detection and correction operation on the data using the parity bits. The error detection and correction operation may be performed in accordance with one or more different algorithms or techniques. For example, the error correction circuitry 265 may include one or more logic components configured to support (e.g., execute) error correction code (ECC), error-detecting code (EDC), other algorithms, or any combination thereof. The I/O component 270 within the data buffer 260 may send the corrected data to the host system 205 after the error correction is performed. In some examples, the I/O component 270 may transfer one or more bits of metadata with the data to indicate that system-level error correction was performed, to indicate whether the errors were corrected or not, to indicate an address of the data, or other information associated with the data. The host system 205 may thereby receive the data with an indication of where error correction was performed, and may determine how to address any potential errors the host system 205 may detect accordingly. It may be beneficial to have all correction capability in the buffer using all of the parity bits retrieved from the memory dies 245. Such system-level error correction may be performed in addition to the on-die error correction, in some examples.

Additionally, or alternatively, techniques described herein may provide for one or more of the on-die ECC engines to be turned off or otherwise disabled, such that the extra parity bits within each memory die 245 may be transferred to the data buffer 260 to enhance the system-level error correction. For example, each memory die 245 may include one or more mode registers 285 configured to indicate whether on-die error correction is enabled or disabled.

If the on-die error correction is disabled at one or more of the memory dies 245, those memory dies may be configured to transfer extra on-die parity bits stored at the memory dies 245 to the data buffer 260. For example, when a read command is received, a memory die 245 may retrieve the requested data and transfer the requested data in addition to one or more of the on-die parity bits to the data buffer 260. The data buffer 260 may use the extra parity bits to perform, by the error correction circuitry 265, the error detection and correction operations. The extra bits (e.g., eight bits from each memory die 245, or 16 bits from each memory die 245, for example) may improve an accuracy and reliability of the system-level error correction. For example, the error correction circuitry 265 may be able to detect and correct an increased quantity of errors with the increased quantity of parity bits. In some examples, if the detection capabilities of the error correction circuitry 265 are increased, the error correction circuitry 265 may detect one or more errors that the error correction circuitry 265 may not be capable of correcting. In such cases, the error correction circuitry 265 may send the data, along with metadata, to the host system 205, where the metadata may indicate that there are uncorrected errors.

By transferring and aggregating all of the parity bits within the memory system 210 at the data buffer 260, the data buffer 260 and error correction circuitry 265 within the data buffer 260 may support error correction for larger portions of data at a time. For example, if an entire memory die 245 is corrupted or otherwise goes down, the increased quantity of parity bits may facilitate reconstruction and correction of the whole memory die 245 by the error correction circuitry 265 at the system level (e.g., chip kill may be replicated in the data buffer 260).

The system-level error correction may be changed dynamically or prior to deployment of the memory system 210. For example, the memory dies 245 may each include a respective mode register 285 that may be set to a certain value during manufacture of the memory system 210, or dynamically throughout operation of the memory system 210. A value of the mode registers 285 may indicate an error correction mode of the memory dies 245 selected from multiple candidate error correction modes. A first value of the mode register 285 may indicate that on-die error correction is enabled, and a second value of the mode register 285 may indicate that on-die error correction is disabled. In some examples, one or more other values may indicate some intermediate level of error correction. The data buffer 260 may similarly include or otherwise be coupled with a mode register 280, which may be configured to indicate whether system-level error correction is enabled or not. A value of the mode register 280 may indicate an error correction mode of the data buffer 260 selected from multiple candidate error correction modes (e.g., enabled, disabled, partially enabled, varying levels of complexity, and the like). The mode registers 280 and 285 may be set by a memory system controller 140, in some examples. Additionally, or alternatively, the memory system 210 my receive some signaling or other indication from the host system 205 indicating the values for the mode registers 280 and 285. In some examples, a user of the system may input the requested mode register values based on a use case of the user or other parameters. Additionally, or alternatively, the allocation of on-die versus system-level error correction may be made during manufacture of the system 200.

In some examples, the error correction circuitry 265 within the data buffer 260 may include one or more logic gates or other components configured to perform varying levels of error correction. For example, the error correction circuitry 265 may support error correction in accordance with a first algorithm and a first quantity of parity bits when on-die error correction is enabled and system-level error correction is enabled using parity bits from one or more dies configured to store only parity information. Additionally, or alternatively, if system-level error correction is disabled, the error correction circuitry 265 may refrain from performing any error correction or detection on the data before transferring the data to the host system 205. If on-die error correction is disabled and system-level error correction is enabled, the error correction circuitry 265 may support error correction in accordance with a second algorithm and a second quantity of parity bits that may be greater than the first quantity. The second algorithm may be more complex and may be capable of correcting more errors per codeword than the first algorithm, in some examples. The logic within the error correction circuitry 265 may similarly support one or more other error correction algorithms based on a value of the mode register(s) 280 and a quantity of parity bits that are available. The data buffer 260 may thereby use a logic process for error correction instead of a DRAM process, or other type of process, which may improve performance of the error correction as compared with only on-die error correction or host-level error correction.

In some examples, the error correction algorithm for a given portion of data may be an example of a key for accessing the portion of the data. For example, once data is written in accordance with a certain error correction algorithm, the data may not be read using any other error correction algorithm. Thus, to switch the error correction algorithm or type of error correction associated with a portion of data from a first error correction algorithm to a second error correction algorithm, the memory system 210 (e.g., the data buffer 260 or the on-die ECC engines 275, or both) may read (e.g., perform an internal read of) the portion of the data from the memory die 245 and decode the portion of the data using the first error correction algorithm. After decoding the portion of the data with the first error correction algorithm, the memory system 310 may encode (e.g., re-encode) the portion of the data using the second error correction algorithm and write (e.g., store) the portion of the data encoded using the second error correction algorithm back to the memory die 245. Subsequent accesses of the portion of the data (e.g., after the switch from the first error correction algorithm to the second error correction algorithm) may include reading (e.g., performing an internal read of) the portion of the data from the memory die 245 and decoding the portion of the data using the second error correction algorithm.

In some examples, if on-die error correction is disabled and system-level error correction is enabled, a size of the memory system 210 may be reduced. For example, one or more extra memory dies 245 may be removed from the memory system 210 during manufacture. If, during manufacture of the memory system 210, the memory system 210 is configured to disable on-die error correction and transfer extra parity bits from the memory dies 245 to the data buffer 260 with any data, then the extra parity bits from each of the memory dies 245 may provide sufficient parity data for the system-level error correction. As such, one or more other memory dies 245 allocated for parity storage may be removed from the memory system 210, which may reduce a footprint of the module, reduce power consumption, and improve storage capacity, among other examples.

The memory system 210 may thereby support system-level error correction using an aggregation of parity bits from across multiple memory dies 245 within the data buffer 260. By aggregating the error correction at the system level within the data buffer 260, the memory system 210 may improve performance and reliability of the error correction while reducing power consumption and overhead via a link between the host system 205 and the memory system 210.

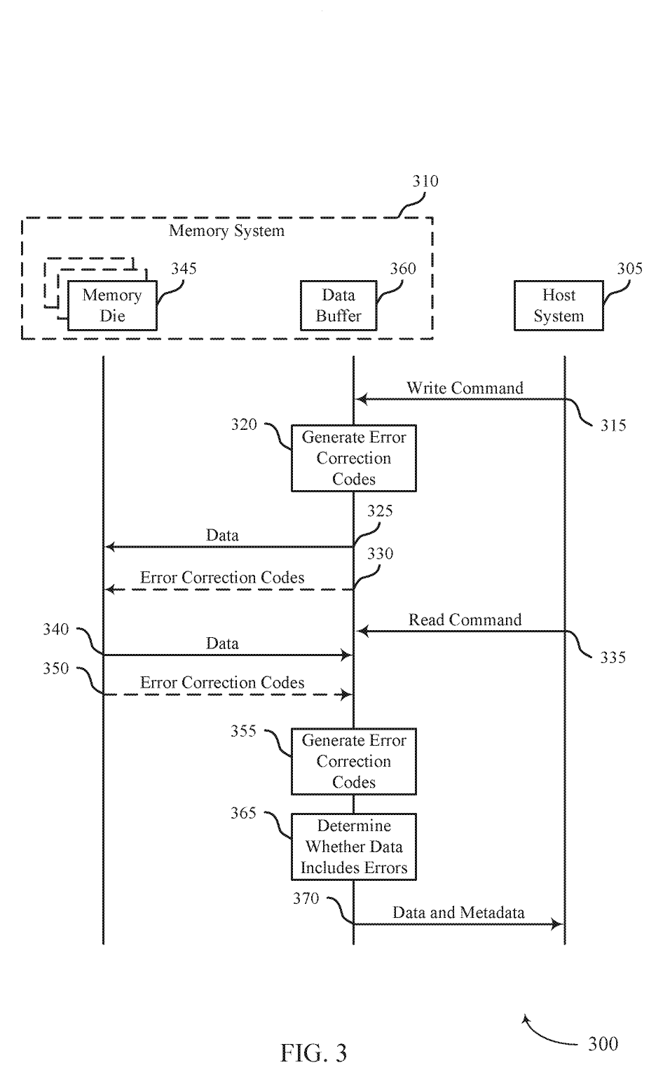

FIG. 3 shows an example of a process flow 300 that supports data buffer error correction functionality in accordance with examples as disclosed herein. The process flow 300 may implement or be implemented by aspects of the system 100 or the system 200, as described with reference to FIGS. 1 and 2. For example, the process flow 300 illustrates exchanges of data and metadata between one or more memory dies 345 and a data buffer 360 within a memory system 310, and between the memory system 310 and a host system 305, which may represent examples of corresponding systems and dies as described with reference to FIGS. 1 and 2. In this example, the data buffer 360 may include error correction capabilities for correcting errors at the system-level prior to transferring data to the host system 305.

At 315, the host system 305 may transmit a write command to the memory system 310 via a link (e.g., one or more channels) between the host system 305 and the memory system 310. The write command and the data associated with the write command may be received by one or more components within the memory system 310, including, in some examples, the data buffer 360, or other components. The memory system 310 (e.g., a memory system controller or other component) may initiate an error correction operation on the data based on receiving the write command.

At 320, as described herein, the error correction circuitry within the data buffer 360 of the memory system 310 may generate, based on the data indicated via the write command, one or more error correction codes (e.g., parity information) associated with the data. The data buffer 360 may generate the error correction codes based on a mode of the data buffer 360 indicating that system-level error correction is supported, in some examples.

At 325, the data buffer 360 may transfer the data indicated via the write command to one or more memory dies 345 within the memory system 310. The data may be stored at one or more target addresses. At 330, in some examples, the data buffer 360 may transmit the error correction codes generated at 320 to the one or more memory dies 345 for storage with the data. Additionally, or alternatively, the data buffer 360 may store the error correction codes at the data buffer, in some examples.

At 335, the host system 305 may transmit a read command to the memory system 310 via the link between the host system 305 and the memory system 310. The read command may indicate one or more addresses associated with the data stored at 325. That is, the host system 305 may request to read the previously stored data.

At 340, in response to the read command, the memory system 310 may retrieve the requested data from one or more memory dies 345. The memory dies 345 may transfer the data to the data buffer 360. If on-die error correction is enabled, the on-die error correction circuitry at the one or more memory dies 345 may correct one or more errors in the data before transferring the data to the data buffer 360. If on-die error correction is disabled, the one or more memory dies 345 may transfer the data and one or more parity bits along with the data. The one or more parity bits may be allocated for on-die error correction, and may be transferred to the data buffer 360 for use in the system-level error correction, as described with reference to FIG. 2.

At 350, in some examples, the memory dies 345 may transfer the error correction codes associated with the data back to the data buffer 360 in response to the read command, if the error correction codes were previously stored at the memory dies 345.

At 355, the data buffer 360 may receive the data associated with one or more memory dies 345 of the memory system 310 and may generate one or more second error correction codes based on the data. For example, the error correction circuitry within the data buffer 360 may generate the second error correction codes using a similar algorithm or technique as used to generate the error correction codes at 320.

At 365, the data buffer 360 may determine whether the data includes one or more errors based on the second error correction codes and the one or more error correction codes stored by the data buffer and previously generated at 320. The data buffer 360 may, for example, compare the error correction codes with the second error correction codes to determine if they are the same or at least within a threshold level of similarity. If the codes are different or sufficiently different from one another, the data buffer 360 may determine that there is at least one error within the data (e.g., may detect an error). If the codes are similar or the same, the data buffer 360 may determine that there is not an error within the data.

The data buffer 360 may correct one or more of the errors in the data, if any are detected at 355. For example, the error correction circuitry within the data buffer 360 may use one or more algorithms and corresponding logic gates to correct the errors. The error correction may be performed using ECC, EDC, hamming codes, Reed-Solomon codes, any other error correction codes, or any combination thereof. The data buffer 360 may perform the error detection and correction using one or more parity bits. In some examples, if on-die error correction is enabled at the memory dies 345, the data buffer 360 may receive the parity bits from one or more second memory dies configured to store the parity information. If on-die error correction is disabled or at least reduced at the memory dies 345, the data buffer 360 may receive the parity bits from the memory dies 345 with the data (e.g., in addition to or instead of the parity received from the second memory dies). The parity bits may represent examples of one or more additional bits that are separate from the data (e.g., different from, do not include the data).

At 370, the data buffer may transfer, via an interface between the data buffer 360 and the host system 305 (e.g., the one or more channels 115), the data and metadata associated with the data. The data buffer 360 may transfer the data based on detecting and/or correcting the one or more errors in the data and in response to the read command. The metadata may, in some examples, indicate whether there are any uncorrected errors in the data. Additionally, or alternatively, the metadata may indicate whether the system-level error correction was performed, one or more addresses associated with errored data, or the like.

The host system 305 may receive the data and the metadata and may determine whether to perform its own error detection and correction. In some examples, the host system 305 may adjust one or more parameters associated with data transfer based on the data and the metadata (e.g., based on a quantity of uncorrected errors, for example).

The memory system 310 described herein may thereby support system-level error correction within a data buffer 360, which may improve reliability and performance of a link between the host system 305 and the memory system 310, among other examples.

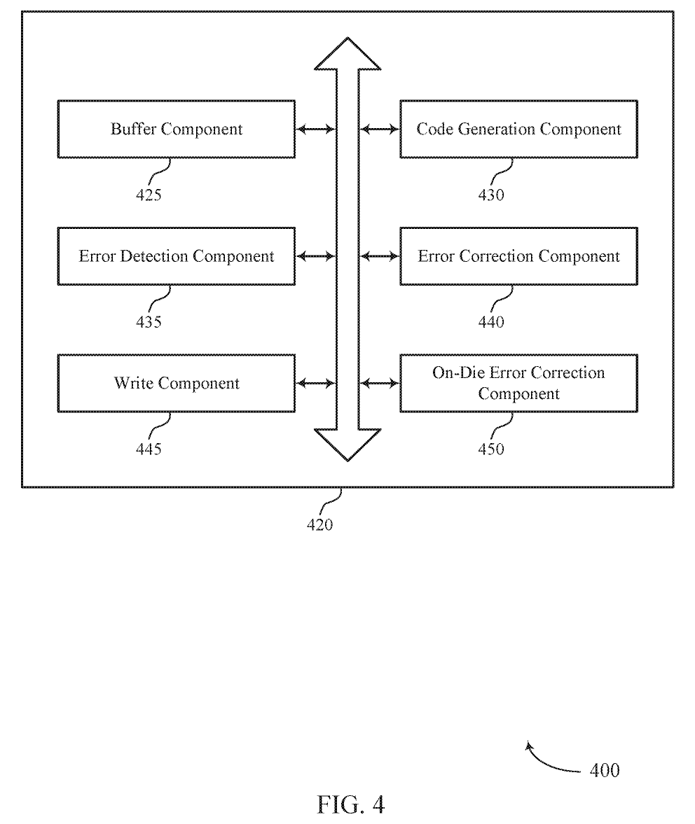

FIG. 4 shows a block diagram 400 of a memory system 420 that supports data buffer error correction functionality in accordance with examples as disclosed herein. The memory system 420 may be an example of aspects of a memory system as described with reference to FIGS. 1 through 3. The memory system 420, or various components thereof, may be an example of means for performing various aspects of data buffer error correction functionality as described herein. For example, the memory system 420 may include a buffer component 425, a code generation component 430, an error detection component 435, an error correction component 440, a write component 445, an on-die error correction component 450, or any combination thereof. Each of these components, or components of subcomponents thereof (e.g., one or more processors, one or more memories), may communicate, directly or indirectly, with one another (e.g., via one or more buses).

The buffer component 425 may be configured as or otherwise support a means for receiving, at a data buffer of a memory system, data associated with a plurality of memory dies of the memory system. The code generation component 430 may be configured as or otherwise support a means for generating, by the data buffer, an error correction code based at least in part on the data. The error detection component 435 may be configured as or otherwise support a means for determining whether the data includes one or more errors based at least in part on the error correction code and one or more error correction codes stored by the data buffer. In some examples, the buffer component 425 may be configured as or otherwise support a means for transferring, via an interface between the data buffer and a host system, the data and metadata associated with the data based at least in part on determining whether the data includes the one or more errors.

In some examples, the code generation component 430 may be configured as or otherwise support a means for receiving, at the data buffer and from the plurality of memory dies, one or more bits that are separate from the data, where generating the error correction code is based at least in part on the one or more bits.

In some examples, the on-die error correction component 450 may be configured as or otherwise support a means for disabling an on-die error correction mode associated with the plurality of memory dies, where receiving the one or more bits from the plurality of memory dies is based at least in part on the on-die error correction mode being disabled.

In some examples, the error correction component 440 may be configured as or otherwise support a means for correcting, by the data buffer based at least in part on determining that the data includes the one or more errors, the one or more errors in accordance with parity information associated with the data, where transferring the data via the interface is based at least in part on correcting the one or more errors.

In some examples, the error detection component 435 may be configured as or otherwise support a means for determining, based at least in part on determining that the data includes the one or more errors, whether the one or more errors exceed a threshold quantity of errors associated with a correction capability of the data buffer. In some examples, the error detection component 435 may be configured as or otherwise support a means for transferring the metadata that indicates the one or more errors based at least in part on determining that the one or more errors exceed the threshold quantity of errors.

In some examples, the write component 445 may be configured as or otherwise support a means for receiving, at the data buffer of the memory system, a write command that indicates to write the data to the plurality of memory dies of the memory system. In some examples, the error correction component 440 may be configured as or otherwise support a means for generating, by the data buffer based at least in part on the write command, the one or more error correction codes associated with the data. In some examples, the error correction component 440 may be configured as or otherwise support a means for storing the one or more error correction codes at the data buffer, the plurality of memory dies, or both, where the one or more error correction codes are stored within one or more bits pulled from the plurality of memory dies.

In some examples, the metadata indicates that a system-level error correction is performed by the data buffer.

In some examples, the metadata indicates one or more addresses associated with a portion of the data that includes the one or more errors.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

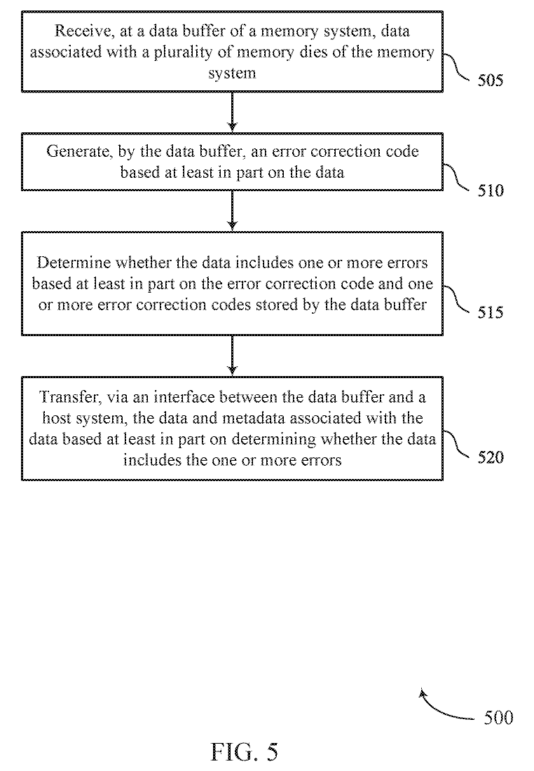

FIG. 5 shows a flowchart illustrating a method 500 that supports data buffer error correction functionality in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving, at a data buffer of a memory system, data associated with a plurality of memory dies of the memory system. In some examples, aspects of the operations of 505 may be performed by a buffer component 425 as described with reference to FIG. 4.

At 510, the method may include generating, by the data buffer, an error correction code based at least in part on the data. In some examples, aspects of the operations of 510 may be performed by a code generation component 430 as described with reference to FIG. 4.

At 515, the method may include determining whether the data includes one or more errors based at least in part on the error correction code and one or more error correction codes stored by the data buffer. In some examples, aspects of the operations of 515 may be performed by an error detection component 435 as described with reference to FIG. 4.

At 520, the method may include transferring, via an interface between the data buffer and a host system, the data and metadata associated with the data based at least in part on determining whether the data includes the one or more errors. In some examples, aspects of the operations of 520 may be performed by a buffer component 425 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing (e.g., to cause the apparatus to perform) the following aspects of the present disclosure:

Aspect 1: A method, apparatus, or non-transitory computer-readable medium including operations, features, circuitry, logic, means, or instructions, or any combination thereof for receiving, at a data buffer of a memory system, data associated with a plurality of memory dies of the memory system; generating, by the data buffer, an error correction code based at least in part on the data; determining whether the data includes one or more errors based at least in part on the error correction code and one or more error correction codes stored by the data buffer; and transferring, via an interface between the data buffer and a host system, the data and metadata associated with the data based at least in part on determining whether the data includes the one or more errors.

Aspect 2: The method, apparatus, or non-transitory computer-readable medium of aspect 1, further including operations, features, circuitry, logic, means, or instructions, or any combination thereof for receiving, at the data buffer and from the plurality of memory dies, one or more bits that are separate from the data, where generating the error correction code is based at least in part on the one or more bits.

Aspect 3: The method, apparatus, or non-transitory computer-readable medium of aspect 2, further including operations, features, circuitry, logic, means, or instructions, or any combination thereof for disabling an on-die error correction mode associated with the plurality of memory dies, where receiving the one or more bits from the plurality of memory dies is based at least in part on the on-die error correction mode being disabled.

Aspect 4: The method, apparatus, or non-transitory computer-readable medium of any of aspects 1 through 3, further including operations, features, circuitry, logic, means, or instructions, or any combination thereof for correcting, by the data buffer based at least in part on determining that the data includes the one or more errors, the one or more errors in accordance with parity information associated with the data, where transferring the data via the interface is based at least in part on correcting the one or more errors.

Aspect 5: The method, apparatus, or non-transitory computer-readable medium of any of aspects 1 through 3, further including operations, features, circuitry, logic, means, or instructions, or any combination thereof for determining, based at least in part on determining that the data includes the one or more errors, whether the one or more errors exceed a threshold quantity of errors associated with a correction capability of the data buffer and transferring the metadata that indicates the one or more errors based at least in part on determining that the one or more errors exceed the threshold quantity of errors.

Aspect 6: The method, apparatus, or non-transitory computer-readable medium of any of aspects 1 through 5, further including operations, features, circuitry, logic, means, or instructions, or any combination thereof for receiving, at the data buffer of the memory system, a write command that indicates to write the data to the plurality of memory dies of the memory system; generating, by the data buffer based at least in part on the write command, the one or more error correction codes associated with the data; and storing the one or more error correction codes at the data buffer, the plurality of memory dies, or both, where the one or more error correction codes are stored within one or more bits pulled from the plurality of memory dies.

Aspect 7: The method, apparatus, or non-transitory computer-readable medium of any of aspects 1 through 6, where the metadata indicates that a system-level error correction is performed by the data buffer.

Aspect 8: The method, apparatus, or non-transitory computer-readable medium of any of aspects 1 through 7, where the metadata indicates one or more addresses associated with a portion of the data that includes the one or more errors.

It should be noted that the aspects described herein describe possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 9: An apparatus, including: one or more memory dies configured to store data; and a data buffer coupled with the one or more memory dies and a host system, the data buffer configured to perform system-level error correction of the data prior to storage in the one or more memory dies, the data buffer including: at least one I/O component configured to transfer the data between the one or more memory dies and the host system; and error correction circuitry configured to detect and correct, as part of the system-level error correction, one or more errors in the data transferred between the one or more memory dies and the host system based at least in part on parity information stored within the apparatus.

Aspect 10: The apparatus of aspect 9, where the one or more memory dies further include: one or more on-die error correction components configured to correct one or more first errors in the data stored at the one or more memory dies before the system-level error correction, by the error correction circuitry, of the one or more errors in the data at the data buffer; and one or more bits allocated for storage of on-die parity information associated with on-die error correction by the one or more on-die error correction components.

Aspect 11: The apparatus of aspect 10, where the one or more on-die error correction components are further configured to: correct the one or more first errors in the data based at least in part on a read command for the data and on an on-die error correction mode being enabled; and transfer the data to the error correction circuitry within the data buffer based at least in part on the read command and correction of the one or more first errors.

Aspect 12: The apparatus of aspect 10, where the one or more on-die error correction components are further configured to: refrain from correcting the one or more first errors in the data based at least in part on a read command for the data and on an on-die error correction mode being disabled; transfer the data to the error correction circuitry within the data buffer based at least in part on the read command; and transfer the one or more bits to the error correction circuitry within the data buffer based at least in part on the on-die error correction mode being disabled.

Aspect 13: The apparatus of any of aspects 9 through 12, where the one or more memory dies are configured to: transfer, from the one or more memory dies to the data buffer based at least in part on a read command associated with the data, the data and one or more bits associated with the data, where the one or more bits are configured for the parity information associated with the system-level error correction based at least in part on an on-die error correction being disabled.

Aspect 14: The apparatus of any of aspects 9 through 13, where the error correction circuitry is further configured to: generate the parity information based at least in part on a write command associated with the data and based at least in part on one or more bits pulled from the one or more memory dies; and store the data indicated via the write command and the parity information in the one or more memory dies.

Aspect 15: The apparatus of aspect 14, where the data buffer is further configured to: retrieve, based at least in part on a read command for a first subset of the data, the first subset of the data from the one or more memory dies; and retrieve, based at least in part on the read command, the parity information from the one or more memory dies, where the system-level error correction by the error correction circuitry is based at least in part on the parity information retrieved from the one or more memory dies.

Aspect 16: The apparatus of any of aspects 9 through 15, where the error correction circuitry is further configured to: detect, as part of the system-level error correction, a first error in the data; and transmit, to the host system, the data and metadata that indicates the first error in the data based at least in part on an error correction capability of the error correction circuitry being less than a threshold capability associated with correction of the first error.

Aspect 17: The apparatus of any of aspects 9 through 16, where the data buffer further includes: one or more mode registers configured to store an indication of an error correction mode of the error correction circuitry within the data buffer, the one or more mode registers coupled with the host system and the one or more memory dies, where the error correction mode is one of a plurality of candidate error correction modes for the error correction circuitry.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component may initiate a change that allows signals to flow between the other components over a conductive path that previously did not permit signals to flow.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., processor-executable code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
one or more memory dies configured to store data; and
a data buffer coupled with the one or more memory dies and a host system, the data buffer configured to perform system-level error correction of the data prior to storage in the one or more memory dies, the data buffer comprising:
at least one input/output component configured to transfer the data between the one or more memory dies and the host system; and
error correction circuitry configured to detect and correct, as part of the system-level error correction, one or more errors in the data transferred between the one or more memory dies and the host system based at least in part on parity information stored within the apparatus.

2. The apparatus of claim 1, wherein the one or more memory dies further comprise:
one or more on-die error correction components configured to correct one or more first errors in the data stored at the one or more memory dies before the system-level error correction, by the error correction circuitry, of the one or more errors in the data at the data buffer; and
one or more bits allocated for storage of on-die parity information associated with on-die error correction by the one or more on-die error correction components.

3. The apparatus of claim 2, wherein the one or more on-die error correction components are further configured to:
correct the one or more first errors in the data based at least in part on a read command for the data and on an on-die error correction mode being enabled; and
transfer the data to the error correction circuitry within the data buffer based at least in part on the read command and correction of the one or more first errors.

4. The apparatus of claim 2, wherein the one or more on-die error correction components are further configured to:
refrain from correcting the one or more first errors in the data based at least in part on a read command for the data and on an on-die error correction mode being disabled;
transfer the data to the error correction circuitry within the data buffer based at least in part on the read command; and
transfer the one or more bits to the error correction circuitry within the data buffer based at least in part on the on-die error correction mode being disabled.

5. The apparatus of claim 1, wherein the one or more memory dies are configured to:
transfer, from the one or more memory dies to the data buffer based at least in part on a read command associated with the data, the data and one or more bits associated with the data, wherein the one or more bits are configured for the parity information associated with the system-level error correction based at least in part on an on-die error correction being disabled.

6. The apparatus of claim 1, wherein the error correction circuitry is further configured to:
generate the parity information based at least in part on a write command associated with the data and based at least in part on one or more bits pulled from the one or more memory dies; and
store the data indicated via the write command and the parity information in the one or more memory dies.

7. The apparatus of claim 6, wherein the data buffer is further configured to:
retrieve, based at least in part on a read command for a first subset of the data, the first subset of the data from the one or more memory dies; and
retrieve, based at least in part on the read command, the parity information from the one or more memory dies, wherein the system-level error correction by the error correction circuitry is based at least in part on the parity information retrieved from the one or more memory dies.

8. The apparatus of claim 1, wherein the error correction circuitry is further configured to:
detect, as part of the system-level error correction, a first error in the data; and
transmit, to the host system, the data and metadata that indicates the first error in the data based at least in part on an error correction capability of the error correction circuitry being less than a threshold capability associated with correction of the first error.

9. The apparatus of claim 1, wherein the data buffer further comprises:
one or more mode registers configured to store an indication of an error correction mode of the error correction circuitry within the data buffer, the one or more mode registers coupled with the host system and the one or more memory dies, wherein the error correction mode is one of a plurality of candidate error correction modes for the error correction circuitry.

10. An apparatus, comprising:
one or more memories storing processor-executable code; and
one or more processors coupled with the one or more memories and individually or collectively operable to execute the code to cause the apparatus to:
receive, at a data buffer of a memory system, data associated with a plurality of memory dies of the memory system;
generate, by the data buffer, an error correction code based at least in part on the data;
determine whether the data comprises one or more errors based at least in part on the error correction code and one or more error correction codes stored by the data buffer; and
transfer, via an interface between the data buffer and a host system, the data and metadata associated with the data based at least in part on determining whether the data comprises the one or more errors.

11. The apparatus of claim 10, wherein the one or more processors are individually or collectively further operable to execute the code to cause the apparatus to:
receive, at the data buffer and from the plurality of memory dies, one or more bits that are separate from the data, wherein generating the error correction code is based at least in part on the one or more bits.

12. The apparatus of claim 11, wherein the one or more processors are individually or collectively further operable to execute the code to cause the apparatus to:
disable an on-die error correction mode associated with the plurality of memory dies, wherein receiving the one or more bits from the plurality of memory dies is based at least in part on the on-die error correction mode being disabled.

13. The apparatus of claim 10, wherein the one or more processors are individually or collectively further operable to execute the code to cause the apparatus to:
correct, by the data buffer based at least in part on determining that the data comprises the one or more errors, the one or more errors in accordance with parity information associated with the data, wherein transferring the data via the interface is based at least in part on correcting the one or more errors.

14. The apparatus of claim 10, wherein the one or more processors are individually or collectively further operable to execute the code to cause the apparatus to:
determine, based at least in part on determining that the data comprises the one or more errors, whether the one or more errors exceed a threshold quantity of errors associated with a correction capability of the data buffer; and
transfer the metadata that indicates the one or more errors based at least in part on determining that the one or more errors exceed the threshold quantity of errors.

15. The apparatus of claim 10, wherein the one or more processors are individually or collectively further operable to execute the code to cause the apparatus to:
receive, at the data buffer of the memory system, a write command that indicates to write the data to the plurality of memory dies of the memory system;
generate, by the data buffer based at least in part on the write command, the one or more error correction codes associated with the data; and
store the one or more error correction codes at the data buffer, the plurality of memory dies, or both, wherein the one or more error correction codes are stored within one or more bits pulled from the plurality of memory dies.

16. The apparatus of claim 10, wherein the metadata indicates that a system-level error correction is performed by the data buffer.

17. The apparatus of claim 10, wherein the metadata indicates one or more addresses associated with a portion of the data that comprises the one or more errors.

18. A method, comprising:
receiving, at a data buffer of a memory system, data associated with a plurality of memory dies of the memory system;
generating, by the data buffer, an error correction code based at least in part on the data;
determining whether the data comprises one or more errors based at least in part on the error correction code and one or more error correction codes stored by the data buffer; and
transferring, via an interface between the data buffer and a host system, the data and metadata associated with the data based at least in part on determining whether the data comprises the one or more errors.

19. The method of claim 18, further comprising:
receiving, at the data buffer and from the plurality of memory dies, one or more bits that are separate from the data, wherein generating the error correction code is based at least in part on the one or more bits.

20. The method of claim 19, further comprising:
disabling an on-die error correction mode associated with the plurality of memory dies, wherein receiving the one or more bits from the plurality of memory dies is based at least in part on the on-die error correction mode being disabled.

21. The method of claim 18, further comprising:
correcting, by the data buffer based at least in part on determining that the data comprises the one or more errors, the one or more errors in accordance with parity information associated with the data, wherein transferring the data via the interface is based at least in part on correcting the one or more errors.

22. The method of claim 18, further comprising:
determining, based at least in part on determining that the data comprises the one or more errors, whether the one or more errors exceed a threshold quantity of errors associated with a correction capability of the data buffer; and
transferring the metadata that indicates the one or more errors based at least in part on determining that the one or more errors exceed the threshold quantity of errors.

23. The method of claim 18, further comprising:
receiving, at the data buffer of the memory system, a write command that indicates to write the data to the plurality of memory dies of the memory system;
generating, by the data buffer based at least in part on the write command, the one or more error correction codes associated with the data; and
storing the one or more error correction codes at the data buffer, the plurality of memory dies, or both, wherein the one or more error correction codes are stored within one or more bits pulled from the plurality of memory dies.

24. The method of claim 18, wherein the metadata indicates that a system-level error correction is performed by the data buffer.

25. The method of claim 18, wherein the metadata indicates one or more addresses associated with a portion of the data that comprises the one or more errors.
